(19) United States
(12) Patent Application Publication
(10) Pub. No.: US 2013/0107218 A1
(43) Pub. Date: May 2, 2013

(54) System for stereoscopic cinema projection

(71) Applicants: Hildegard Ebbesmeier, Schweppenhausen (DE); Lingli Wang, Bad Kreuznach (DE); Udo Schauss, Waldbockelheim (DE)

(72) Inventors: Hildegard Ebbesmeier, Schweppenhausen (DE); Lingli Wang, Bad Kreuznach (DE); Udo Schauss, Waldbockelheim (DE)

(73) Assignee: JOS. SCHNEIDER OPTISCHE WERKE GMBH,, Bad Kreuznach (DE)

(21) Appl. No.: 13/697,335

(22) PCT Filed: May 6, 2011
(86) PCT No.: PCT/EP2011/057319

§ 371 Date: Jan. 8, 2013

(30) Foreign Application Priority Data
May 11, 2010 (DE) 10 2010 020 244.4

(51) Int. Cl. G02B 27/26

(52) U.S. Cl. CPC G02B 27/26
USPC 353/8; 353/121

(57) ABSTRACT

A system for stereoscopic cinema projection comprising at least one projector for projecting two images, one image for a first eye and one image for a second eye of a viewer, is proposed. The beam paths of the light emerging from the projector respectively run through a linear polarizer to a correspondingly assigned projection lens. After passing through the projection lens, the beam paths of the two images, which are different for the eyes of a viewer, run through a radial and respectively a tangential polarization filter and are simultaneously projected, with different polarization states, exactly one on top of the other onto a metallic projection wall. By means of a visual aid for both eyes of a viewer, the lenses of which are configured differently for each eye with a radial and respectively a tangential polarization filter, each partial image is made visible only for the first or left eye or the second or right eye (or vice versa) and the 3D impression is thus generated for the viewer.

### FIELD OF THE INVENTION

The invention relates to an optical system for the projection of stereoscopic images, in particular in 3D cinema projection.

### PRIOR ART

In the stereoscopic projection, for spatially faithful imaging, pairs of images, also designated as stereoscopic half-images or partial images, are generated separately for each eye and offered for viewing. The methods and techniques used here for generating and reproducing three-dimensional images are based on the principle of natural vision with two eyes. Owing to the distance between the two eyes, the left eye sees an object from a somewhat different viewing direction than the right eye. These—perspectively different—views are merged in the visual center of the human brain to form a single three-dimensional perception. In stereoscopy, this is simulated by means of two imagings (images), the perspectivity of which corresponds to that of the interocular distance. In order to generate the stereo effect (3D effect) for the viewer, the two half-images are projected one on top of the other onto a projection wall, but these stereoscopic partial images have to be offered to the eye separately in order that only the left image becomes visible to the left eye and only the right image becomes visible to the right eye.

On these images, each spatial point is imaged by corresponding pixels on each half-image which are slightly laterally displaced with respect to one another on account of parallax (=stereoscopic deviation) and by means of which, in contrast to a two-dimensional image, it is possible to determine the depth position of each spatial point from the image in a mathematically reproducible manner and the viewer can perceive the spatial position of each imaged spatial point on account of a presentation—coming close to naturalness.

All other properties of a two-dimensional image, such as perspective distortion depending on the lens focal length, the color and, in particular, however, also the restrictive tying of the viewer with respect to location, are maintained.

In 3D cinema projection, at the present time a number of methods are used for reproducing stereoscopic images (films), and these methods can be classified in four categories, for example, according to the type of aids used:
aid-free stereo reproduction, which allows stereoscopic contents to be viewed without special goggles, displays or other aids. However, the methods used here require a conscious separation of the image perception by the human eye and therefore has to be trained by the viewer;
passive systems, in which reproduction takes place on a conventional, two-dimensional medium and is viewed using goggles without electronic driving. The spatial impression for the viewer is immediately established by virtue of the goggles. Passive systems also include, inter alia, polarization technology;
active systems, which likewise use a two-dimensional reproduction medium, but they have active electronic driving of the goggles. This category includes, for example, all variants of systems with shutter glasses;
head mounted displays, autostereoscopic displays and other constructions specifically optimized or developed for 3D reproduction are combined to form the group of 3D displays.

Polarization technology utilizes the polarization properties of light for channel separation. A distinction is made between linear and circular polarization. Both variants are used for stereo projection, linear polarization being used the most frequently by far.

Reproduction is generally effected by means of two projectors, wherein, in the case of linear polarization, polarization filters offset by 90°, also called pole filters, are positioned in front of the lenses. In many cases a so-called V-arrangement is preferred, i.e. a polarization direction of 45° is used for the right representation, and 135° for the left representation. The two images are projected synchronously one on top of the other on a polarization-maintaining screen (projection wall) and viewed through goggles with pole filters in the same arrangement.

An optimum suppression of interference images is only achieved if the filters in front of the projectors (polarizers) and in the goggles (analyzers) are oriented at exactly the same angle. In this context, however, linear pole filter technology has a significant weakness. If the viewer inclines his/her head, then a difference angle arises between polarizer and analyzer and the interference image proportion increases greatly.

This problem is avoided with the use of circular pole filters. In that case, however, it is disadvantageous that the circular pole filters chosen exhibit an optimum behavior only for a specific wavelength, which is usually chosen in the center of the visible spectrum. However, poorer channel separation then occurs at the edges of the visible spectrum.

Therefore, the linear technology, which has a smaller interference image proportion compared with the circular technology, at least in the case of exact orientation, is generally still used very frequently. The 3D reproduction quality that can be achieved is greatly dependent on the filters used and the projection wall. A metalized surface is usually used as the projection surface. However, the polarizers absorb a proportion of the light, and so projectors having higher luminous intensity are required in comparison with a two-dimensional presentation. Therefore, polarization technology is currently still primarily the standard method for high-quality projections for a large audience, since, inter alia, the goggles are also inexpensive to procure.

### Problem

The problem addressed by the invention is that of specifying an optical system for projecting stereoscopic images which has a high imaging performance and enables the 3D images to be viewed to the greatest possible extent without any errors, independently of the difference angle between polarizer and a visual aid (analyzer; passive goggles) of a viewer.

### Solution

This problem is solved by the inventions comprising the features of the independent claims. Advantageous developments of the inventions are characterized in the dependent claims. The wording of all the claims is hereby incorporated by reference in the content of this description. The invention also encompasses all expedient and, in particular, all mentioned combinations of independent and/or dependent claims.

A system for stereoscopic cinema projection is proposed, comprising the following elements:

a) at least one projector for projecting two images, one image for a first eye and one image for a second eye of a viewer;

b) a linear polarizer for polarizing the light emerging from the projector;

c) a respective projection lens in front of each of the at least one projectors;

d) a radial polarization filter for light which projects the image for the first eye of the viewer;

e) a tangential polarization filter for light which projects the image for the second eye of the viewer;

f) a metallic projection wall, onto which the images are projected; and

g) a visual aid for both eyes of a viewer, wherein a first spectacle lens contains a radial polarization filter and a second spectacle lens contains a tangential polarization filter.

The projectors used can be two identical projectors with identical lenses and light sources. In this case, the generation of the stereoscopic partial images by the projectors can be realized according to the analog method with conventional film material or digitally.

The two partial images supplied by the projectors are respectively provided only for perception by one of the eyes of the viewer, that is to say that each partial image is made visible only for the first or left eye or the second or right eye (or vice versa). For this purpose, both partial images are projected exactly one on top of the other onto a projection wall.

Advantageously, a linear polarizer for polarizing the light emerging from the projector is arranged between the image-generating unit and the projection lens in the beam path for each partial image. In this case, the polarization directions of the two linear polarizers can be offset by 90 degrees with respect to one another. However, it is also possible to use only one polarizer for both partial images. Moreover, the linear polarizer can also be arranged between projection lens and projection wall.

In addition, a further polarization of the light coming from the projectors is effected at the output of the respective projection lens. This is done by arranging a radial polarizer of the light of the partial image for the left eye and a tangential polarizer of the light of the partial image for the right eye of the viewer, or vice versa.

Light is a transverse electromagnetic wave whose field vector oscillates perpendicularly to the propagation direction. Light whose field vector E oscillates only in one direction is called linearly polarized light. In this case, the polarization direction is the direction in which the field vector E oscillates. Upon reflection, the incident ray and the reflected ray define the so-called plane of incidence, which is perpendicular to the reflection surface. Light whose polarization plane is perpendicular to the plane of incidence is called s-polarized light, and light whose polarization plane is parallel to the plane of incidence is called p-polarized light.

Tangential polarization is present if the light is linearly polarized in the pupil of an optical system and the polarization direction in this case changes over the pupil, such that the polarization direction is perpendicular to the radius vector at every location of the pupil. The radius is defined by the midpoint of the pupil or proceeds from the optical axis. By contrast, radial polarization is present if the polarization direction is radial with respect to the optical axis (parallel to the radius vector) at every location of the pupil.

In other words, “tangential polarization” is understood to mean a polarization distribution in which the planes of oscillation of the electric field strength vectors of the individual linearly polarized light rays are oriented approximately perpendicularly to the radius directed toward the optical axis. By contrast, in the case of “radial polarization”, a polarization distribution is present in such a way that the planes of oscillation of the electric field strength vectors of the individual linearly polarized light rays are oriented approximately radially with respect to the optical axis.

It is therefore characteristic of radial and tangential polarization that although the electric field oscillates—as ever—perpendicularly to the propagation direction, it does not oscillate just in one direction, in contrast to linear polarization.

In order to maintain the polarization properties of the light of the two partial images that is reflected from the projection wall to the visual aid and thus to the eyes of the viewer, it is necessary to use a metallic projection wall. It is advantageous to use for this a so-called silver screen without surface sealing (plastic coating). Although such a polarization-maintaining screen is called a silver screen, it is generally not coated with silver, but rather with aluminum particles.

The polarization filters in front of each lens of the individual projectors are designed such that, via a visual aid (spectacles or goggles) associated with the system and comprising identically polarizing spectacle lenses, the left eye sees only the left partial image and the right eye of the viewer sees only the right partial image projected onto the projection wall, that is to say that the visual aid is passive spectacles for a viewer, the first and second spectacle lenses of which each have a different polarization corresponding to the polarization direction of the polarizers at the output of the respective projector.

The tangential and/or radial polarizers can advantageously be embodied on the basis of CGHs (CGH=computer generated hologram). Almost all arbitrary beam shapes and beam directions can thereby be generated. Computer generated holograms (CGH) are important elements in modern optics for generating application-specific optical fields and functions. With the aid of micro- and nanostructures, with these elements predefined wavefronts are generated which cannot be realized by methods in traditional optics. CGHs are used, inter alia, in the interferometric testing of high-precision aspherical lens elements or for splitting an illumination beam into a multiplicity of spots of equal brightness.

A computer generated hologram is an individually calculated hologram that is written into a functional layer after calculation.

CGHs are realized, for example, with high precision in plastic substrates. A CGH can be stored as a phase hologram by changing the local optical properties of, for example, a polymer carrier. The different local optical properties of the individual dots can be reflection properties, for example as a result of surface topography, or varying optical path lengths in the material of the functional layer (refractive indices), of the material. The desired local optical properties of the individual dots are calculated by a computer.

Such computer generated holograms consist of one or more layers of dot matrices or dot distributions. In this case, the dot distribution can be embodied as an amplitude hologram or phase hologram.

In the case of the invention, one advantageous embodiment is achieved by the use of two so-called polarizing CGHs (PCGH).

The publication “Polarization configurations with singular point formed by computer generated holograms” [E. G. Churin, J. Hoβfeld and T. Tschudi; Optics Communications, Volume 99, Issues 1-2, 15 May 1993, Pages 13-17]—the content of which is hereby incorporated by reference in this description—describes in this respect, for example, the conversion of a linearly polarized laser beam by means of two cemented PCGHs and a Lambda/4 plate into a point-symmetrical beam with linear dependence of the polarization direction on the angular position of the beam. Both a tangentially polarized beam and a radially polarized beam can be generated in this way. It is merely necessary to use in each case a suitably prepared PCGH, as described in the cited publication.

In one advantageous embodiment of the invention, the system can comprise a projector containing a DMD for projecting digitally stored image contents.

The digitally stored image contents are projected by means of DLP technology (DLP=Digital Light Processing), on the basis of DMDs (DMD=Digital Mirror Device).

In this case, one-chip technology or 3-chip technology can be used, i.e. with or without a beam combiner depending on the technology.

In the case of a 1-chip projector, a color wheel is interposed into the light path in front of the DMD chip, color filters of the primary colors (generally red, green and blue, but in some instances even further colors as well) rotating on said color wheel. In order to achieve better brightness values in the white, a white sector can also be added to the color wheel as well. With the position of the color filter, the electronics change the partial image reflected from the DMD. On account of the rotational speed of the color wheel and the inertia of the human eye, the partial images are added to form a color image impression.

In a 3-chip projector, the light downstream of the light source (lamp) is decomposed by dichroic mirrors into the three primary colors red, green and blue and distributed individually among three DMD chips. The respective partial reflection of the individual DMDs is added again in a so-called dichroic prism, which contains two crossed dichroic mirrors, to form the complete color image (beam combiner). The beam path runs from there to the projection lens.

A further advantageous embodiment of the invention can be fashioned in such a way that the system comprises a “field flattener” lens element (is also designated as “image field flattener lens element”) in the beam path between the DMD and the projection lens. The projection lenses designed for analog film are optimized toward a curved image plane which is established in a temperature-defined manner in the case of the celluloid film material used. One possibility for adapting such a system to the conditions for digital projection is, for example, the use of the aforementioned field flattener lens element. The field flattener lens element serves, in the case of digital projection, to compensate to the greatest possible extent for the properties of the lens optimized for analog projection with regard to the curvature properties of a conventional analog celluloid film, i.e. to improve the image sharpness and to reduce edge distortions, in order to achieve an acceptable imaging quality on the projection wall. The field flattener less element is arranged in direct proximity to the DMD. The lens element is generally embodied as an individual lens element. It has one plane surface and one concave surface, the plane surface facing the DMD/beam combiner.

In this way, conventional lenses for analog projection can be used for digital projection.

In another advantageous embodiment of the invention, the system is fashioned such that, in the case of digital projection, an optical relay system is arranged in the beam path between the DMD and the projection lens. In this case, the optical relay system is arranged in such a way that a real image of the image output by a DMD is generated in the beam path before the projection lens, which image is then projected onto the projection wall by a projection lens which can have a short vertex focal length. This embodiment variant is a further possibility of adapting a projection lens optimized for analog projection to the conditions of digital projection, since a higher vertex focal length is generally required in digital projection in order to have enough space for a beam combiner.

Projection lenses optimized for analog projection have a shorter vertex focal length. Therefore, they cannot be used for the digital projection without further adaptation, since relatively long prisms are used as beam combiners in the case of digital projection.

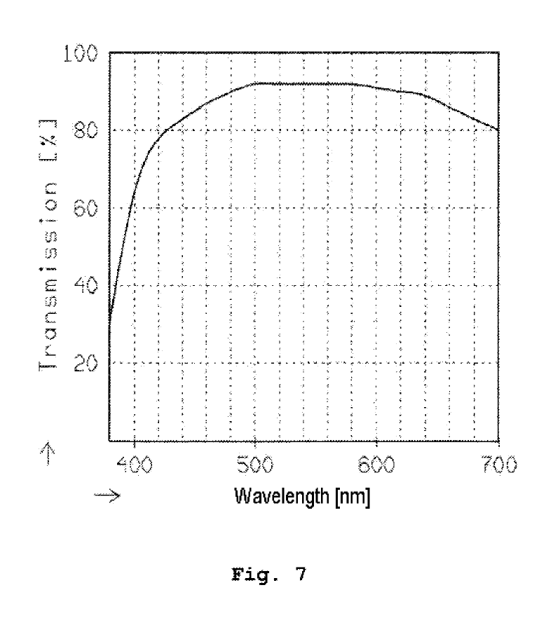

In this case, the realization of the invention with an optical relay system can be implemented, for example, such that a relay system integrated in the projector, as is described e.g. in U.S. Pat. No. 6,676,260 “Projection apparatus using spatial light modulator with relay lens and dichroic combiner” (FIG. 6 and FIG. 7; column 13, line 10 to column 14, line 47), is used (the disclosure in the cited passages is hereby incorporated by reference in this description). That makes it possible also to use lenses having a short vertex focal length which are already used for analog projection. Since these lenses are designed for a curved image field, owing to the temperature-induced film curvature in the case of analog projection, it is necessary to correct the image field curvature that is system-typical for these lenses once again by means of an “image field flattener lens element” arranged near the intermediate image generated by the relay system. This is because the real intermediate image generated by the cited relay system is planar.

It is advantageous if the linear polarizer for polarizing the light emerging from the projector is a wire grid polarizer (WGP).

The wire grid polarizer consists of an arrangement of parallel wires. It is transmissive only to electromagnetic waves whose polarization is perpendicular to the wires, and it has very high heat resistance on account of its metallic construction.

It is also advantageous if the linear wire grid polarizer is arranged between projector and projection lens.

Since high evolution of heat can be registered in the region between imaging unit and projection lens in the case of cinema projectors, it is particularly expedient, in order to realize a high heat resistance, for the linear polarizers to be expediently embodied as wire grid polarizers.

In one advantageous embodiment, the projection lens of the projector is fashioned in such a way that it has a stereoscopic pair of imaging systems situated on both sides of an axial separating plane, wherein the optical construction of the two imaging systems is identical, a partial image beam path is realized for each of the two eyes of the viewer, and wherein the axial separating plane preferably brings about a horizontal splitting of the projection lens.

This construction of the projection lens makes it possible for only exactly one projector to be required, which can realize the projection of the two partial images for the right and left eyes of the viewer by means of this one, preferably horizontally split, lens (“split lens”). Lenses of this type are described e.g. in DE 34 36 853 C2 or U.S. Pat. No. 4,235,503.

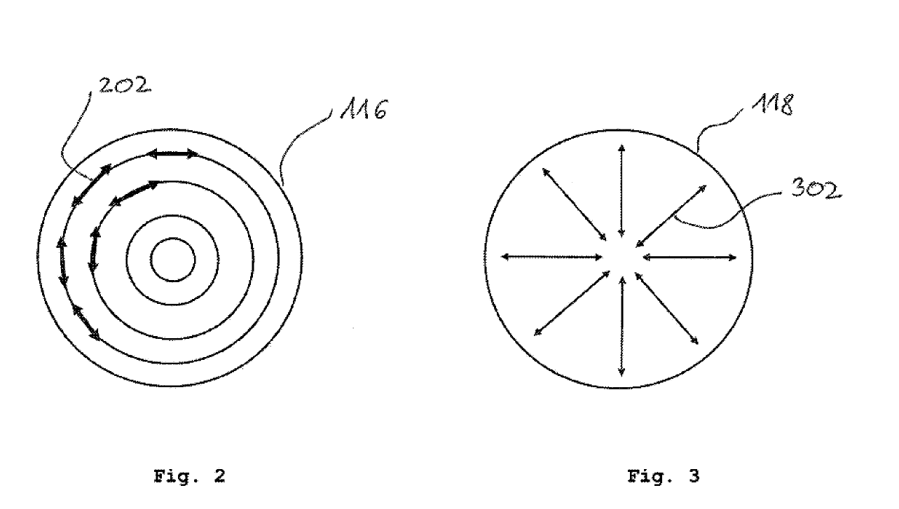

In the case of the described system for 3D cinema projection, it is possible to use, alongside analog projection lenses, also projection lenses calculated/optimized specifically for digital projection, e.g. a digital lens having the optical properties described in DE 10 2006 006 981 A1 “Projektionsobjektiv für die digitale Kinoprojektion” [“Projection lens for digital cinema projection”] (paragraph [0082] to paragraph [0094]; FIG. 2 to FIG. 6; Table 1). Such lens designs can also be used in the configuration of a “split lens”. The disclosure in the passages cited here is hereby incorporated by reference in this description.

The invention furthermore also includes a method for stereoscopic cinema projection comprising the following steps:

a) at least one projector projects two images, one image for a first eye and one image for a second eye of a viewer;

b) a linear polarizer polarizes the light emerging from the projector;

c) each of the two images is projected by means of a respective projection lens in front of each of the at least one projectors;

d) a radial polarization filter polarizes the light which projects the image for the first eye of the viewer;

e) a tangential polarization filter polarizes the light which projects the image for the second eye of the viewer;

f) the images are projected onto a metallic projection wall and

g) by means of a visual aid, the images reach the two eyes of a viewer,

wherein a first spectacle lens of the visual aid contains a radial polarization filter and a second spectacle lens contains a tangential polarization filter,

wherein in each case only the image with the polarization identical to the spectacle lens becomes visible on the respective first or second eye of the viewer.

Further details and features will become apparent from the following description of preferred exemplary embodiments in conjunction with the dependent claims. In this case, the respective features can be realized by themselves or as a plurality in combination with one another. The possibilities for solving the problem are not restricted to the exemplary embodiments. Thus, by way of example, range indications always encompass all intermediate values—not mentioned—and all conceivable sub-intervals.

The exemplary embodiments are illustrated schematically in the figures. In this case, identical reference numerals in the individual figures designate elements that are identical or functionally identical or correspond to one another with regard to their functions. In the figures, specifically:

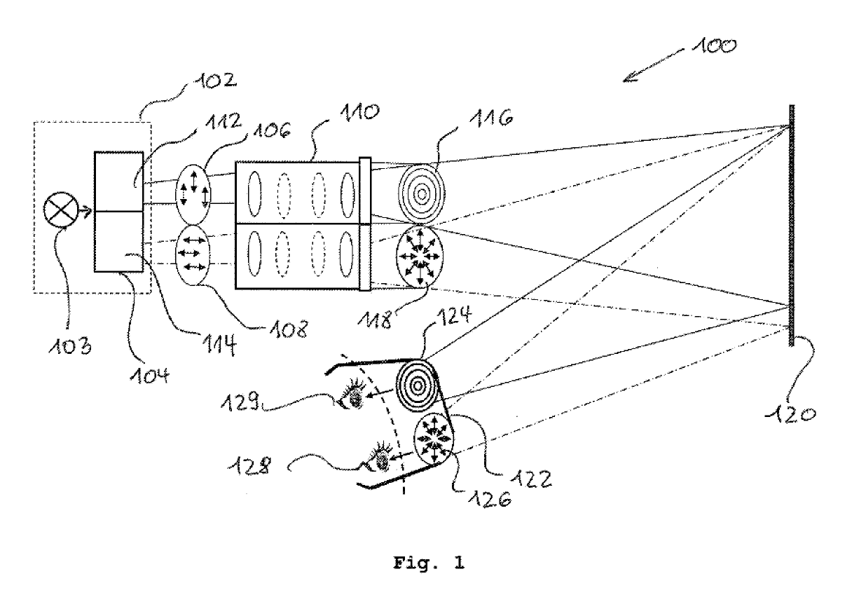

FIG. 1 shows a schematic illustration of the system for 3D cinema projection;

FIG. 2 shows a schematic illustration of a radial polarization filter;

FIG. 3 shows a schematic illustration of a tangential polarization filter;

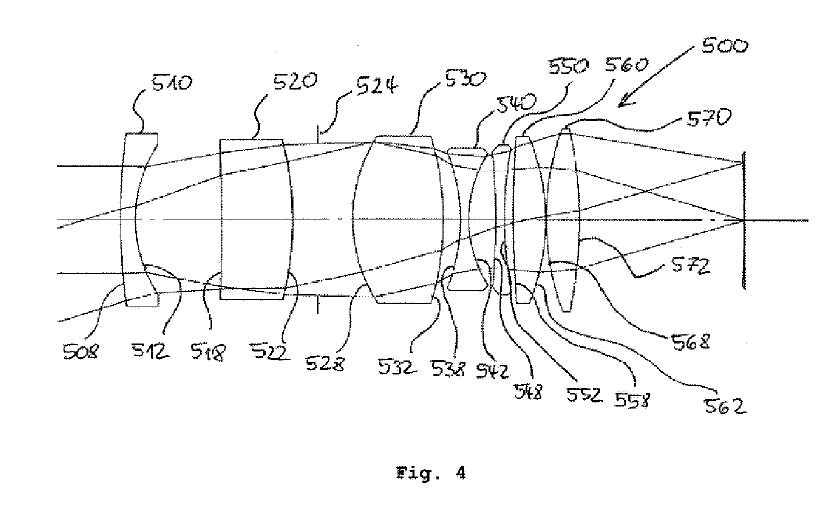

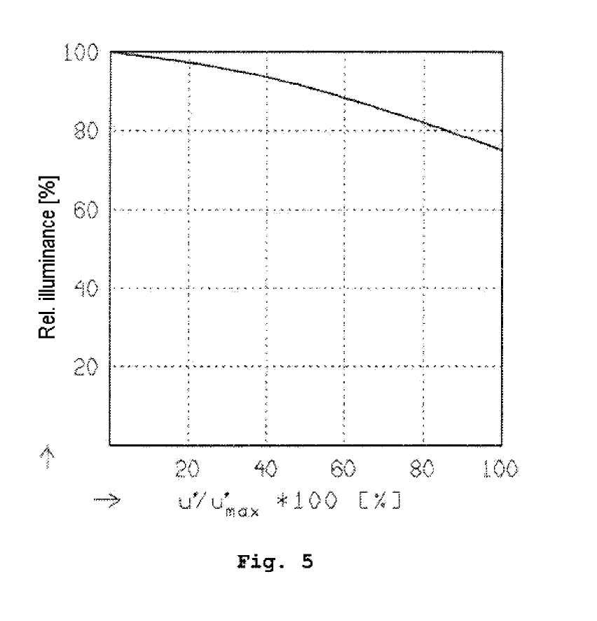

FIG. 4 shows, as an exemplary embodiment, a schematic illustration of the lens element arrangement of a projection lens having a focal length of 45 mm;

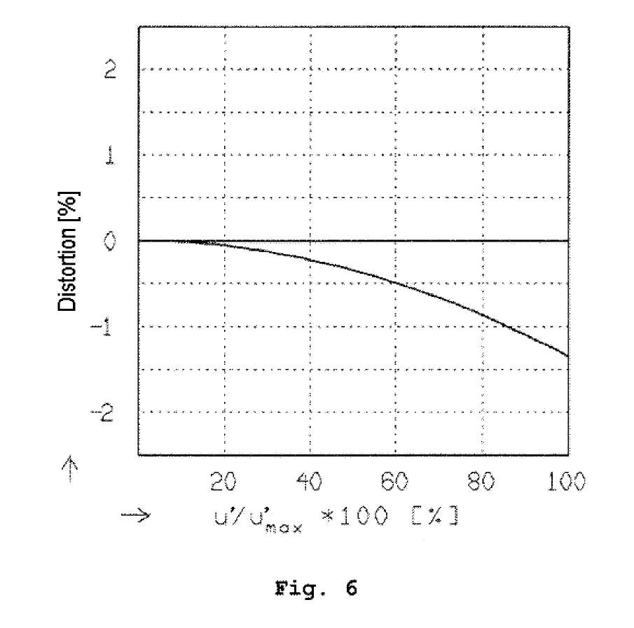

FIG. 5 shows a graphical illustration of the relative illuminence of the projection lens in accordance with FIG. 5;

FIG. 6 shows a graphical illustration of the distortion of the projection lens in accordance with FIG. 5;

FIG. 7 shows a graphical illustration of the transmission of the projection lens in accordance with FIG. 5; and

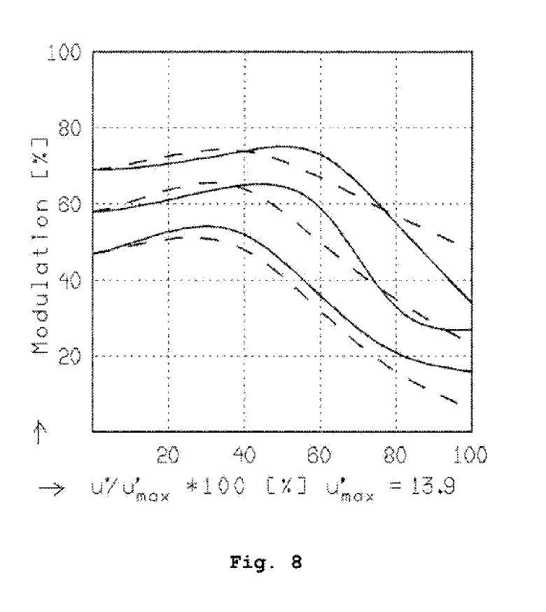

FIG. 8 shows a graphical illustration of the modulation of the projection lens in accordance with FIG. 5 as a function of the relative image size in the case of k=1.8.

The technical data of the projection lens illustrated in FIG. 4 are listed in Tables 1 and 2. In the tables, specifically:

Table 1 shows a list of the radii, the thicknesses or air clearances, the refractive indices and the Abbe numbers of the projection lens illustrated in FIG. 4;

Table 2 shows a list of the aspheric coefficients of the projection lens illustrated in FIG. 4.

The schematic illustration in FIG. 1 shows a system 100 for stereoscopic (3D) cinema projection comprising:
a projector 102;
a light source 103;
an imaging unit 104 for the two stereoscopic partial images 112 and 114;
two linear polarizers 106, 108;
the projection lens 110 (split lens);
a tangential polarizer 116;
a radial polarizer 118;
a projection wall 120; and
spectacles or goggles 122 for the viewer comprising tangentially and radially polarizing spectacle lenses 124 and 126, respectively.

The two stereoscopic partial images 112, 114 are generated by a projector 102 comprising a light source 103 and the imaging unit 104. The beam path of each of the two partial images passes through a linear polarizer 106 or 108. Both polarizers have e.g. a polarization direction offset by 90 degrees with respect to one another.

These linearly polarized partial images 112, 114 are projected onto a projection wall 120 by means of the projection lens 110 embodied as a “split lens”. Downstream of the projection lens 110 in the direction of the projection wall 120, the two partial images pass through a tangential polarizer 116 and a radial polarizer 118, respectively, and from there pass to the projection wall 120. From this polarization-maintaining projection wall 120 embodied as a “silver screen”, the light of the differently polarized partial images is reflected to the spectacles or goggles 122 of the viewer. By virtue of the spectacles 122 being equipped with the differently polarizing spectacle lenses 124 and 126, the effect achieved is that each of the eyes 128, 129 of the viewer sees in each case only the partial image identical to the polarization of the corresponding spectacle lens 124, 126. The two partial images are combined in the viewer's perception to form the desired stereoscopic total image, wherein an image quality that is to the greatest possible extent independent of inclination movements of the viewer and an optimum channel separation are advantageously realized by means of the technology used with regard to the polarization of the partial images.

FIG. 2 schematically shows the polarizing effect of a tangential polarization filter 116. The polarization vector distribution over a beam cross section is shown. In the case of tangential polarization, the planes of oscillation of the electric field strength vectors 202 of the individual linearly polarized light beams are oriented perpendicularly to the radius directed toward the optical axis.

The polarizing effect of a radial polarization filter 118 is shown schematically in FIG. 3. In the case of radial polarization, the polarization distribution is such that the planes of oscillation of the electrical field strength vectors 302 of the individual linearly polarized light beams are oriented approximately radially with respect to the optical axis.

The exemplary embodiment illustrated in FIG. 4 concerns the lens element arrangement of a projection lens having a focal length of 45 mm and an F-number of 1.8. In the illustration in accordance with FIG. 5, the projection wall or the magnified image is situated on the left and the object or the digital image medium is situated on the right. In the exemplary embodiment, the projection lens consists of the following elements, in the order from the projection wall to the DMD or image medium, i.e. from left to right:

a) a first, negative meniscus lens element 510, the concave surface 508 of which faces away from the projection wall;

b) a second, positive meniscus lens element 520, the concave surface 518 of which faces the projection wall, lens element 520 having an aspherical surface 522;

c) a diaphragm 524;

d) a third, positive biconvex lens element 530, the flatter convex surface 532 of which faces away from the projection wall;

e) a fourth, negative biconcave lens element 540, the flatter concave surface 538 of which faces the projection wall;

f) a fifth, negative biconcave lens element 550, the flatter concave surface 548 of which faces the projection wall;

g) a sixth, positive biconvex lens element 560, the flatter convex surface 558 of which faces the projection wall;

h) a seventh, positive biconvex lens element 570, the flatter surface 572 of which faces away from the projection wall.

The projection lens described can be embodied as an individual lens for a respective projector, or as a combined lens (“split lens” type), wherein, when using a combined lens, only one projector and one lens are required for generating and projecting the two stereoscopic partial images. In the case of the combined lens, the optical construction within the lens in the beam paths for the two partial images is identical.

The precise specifications with regard to the individual surfaces of the optical elements of the exemplary embodiment in accordance with FIG. 4 are found in Table 1.

The aspheric coefficients of the lens element surface 522 of the projection lens in accordance with FIG. 4 are listed in Table 2. In this case, K specifies the so-called cone constant. The values A4, A6, A8 and A10 represent the so-called aspheric coefficients, which are the coefficients of a polynomial expansion of the function for describing the surface 522 of the asphere.

Some characteristic parameters of the projection lenses in accordance with the exemplary embodiment in FIG. 4 are illustrated graphically in FIGS. 5 to 8.

FIG. 5 shows the relative illuminance of the magnified image compared to the center for the projection lens in accordance with FIG. 4. The x-axis indicates the relative deviation from the center of the image to be magnified in the case of an F-number of 1.8.

FIG. 6 shows the distortion for the projection lens in accordance with the exemplary embodiment in FIG. 4 in percent (%) of the deviation from the ideal image size. The positive values characterize pincushion distortion, while the negative values concern barrel distortion. The x-axis indicates the relative deviation from the center of the image to be magnified in the case of an F-number of 1.8.

FIG. 7 graphically shows the profile of the transmittance in percent (%) for the projection lens in accordance with the exemplary embodiment in FIG. 4 as a function of the wavelength.

FIG. 8 illustrates the resolution (modulation) of the projection lens from FIG. 4. The x-axis indicates the relative deviation from the center of the image to be magnified in the case of an F-number of 1.8. The resolution was calculated for human eye sensitivity. The following weighting of the wavelengths was used: 546 nm with 28.3%, 644 nm with 4.5%, 610 nm with 17.8%, 570 nm with 29.4%, 510 nm with 16.0% and 480 nm with 4.0%.

Three examples were calculated: the upper two curves are associated with the example with a spatial frequency of 20 line pairs per mm (LP/mm), the middle two curves are associated with 40 LP/mm and the lower two curves with 80 LP/mm. The solid line in each case shows the resolution of radially running line pairs, and the dashed line the resolution of tangentially running line pairs.

The x-axis indicates the relative deviation from the center of the image. The modulation transfer function in the case of an F-number k of 1.8 is represented on the y-axis.

### REFERENCE NUMBERS

100 System for stereoscopic projection
102 Projector for the projection
103 Light source for the projection
104 Imaging unit for first respectively second partial image
106 Linear wire grid polarizer (WGP) for first partial image
108 Linear wire grid polarizer (WGP) for second partial image
110 Projection lens (“split lens” type)
112 Real first partial image at the input of the projection lens
114 Real second partial image at the input of the projection lens
116 Polarizer (tangential polarization)
118 Polarizer (radial polarization)
120 Projection wall (silver screen)
122 Visual aid (spectacles or goggles) of the viewer comprising tangentially and radially polarized lenses
124 Spectacle lens having tangential polarization
126 Spectacle lens having radial polarization
128 First eye of the viewer
129 Second eye of the viewer
202 Polarization direction of the light at the tangential polarizer
302 Polarization direction of the light at the radial polarizer
500 Lens element arrangement of a projection lens
508 1st surface of the lens element 510
510 Negative meniscus lens element
512 2nd surface of the lens element 510
518 1st surface of the lens element 520
520 Positive meniscus lens element
522 2nd surface (aspherical) of the lens element 520
524 Diaphragm
528 1st surface of the lens element 530
530 Biconvex lens element
532 2nd surface of the lens element 530
538 1st surface of the lens element 540
540 Biconcave lens element
542 2nd surface of the lens element 540
548 1st surface of the lens element 550
550 Biconcave lens element
552 2nd surface of the lens element 550
558 1st surface of the lens element 560
560 Biconvex lens element
562 2nd surface of the lens element 560
568 1st surface of the lens element 570
570 Biconvex lens element
572 2nd surface of the lens element 570

### CITED LITERATURE

### Patent literature

DE 34 36 853 C2 “Stereo-Projektionsobjektiv mit Wärmeschutzfilter” [“Stereo projection lens with thermal protection filter”].

U.S. Pat. No. 4,235,503 “Film projection lens system for 3D-movies”.

U.S. Pat. No. 6,676,260 “Projection apparatus using spatial light modulator with relay lens and dichroic combiner”.

DE 10 2006 006 981 A1“Projektionsobjektiv für die digitale Kinoprojektion” [“Projection lens for digital cinema projection”].

### Non-Patent Literature

E. G. Churin, J. Hoβfeld and T. Tschudi: “Polarization configurations with singular point formed by computer generated holograms”; Optics Communications, Volume 99, Issues 1-2, 15 May 1993, Pages 13-17.

TABLE 1
Focal length = 45 mm, F-number = 1.7

| | | Thicknesses of | Refractive | Abbe |
|---|---|---|---|---|
| Reference | Radius | air clearances | index | number |
| sign | [mm] | [mm] | n_{d} | ν_{d} |
| 508 | 157.29 | | | |
| 510 | | 3.50 | 1.5168 | 64.1 |
| 512 | 32.27 | | | |
| | | 20.29 | 1.0000 | |
| 518 | −504.83 | | | |
| 520 | | 16.91 | 1.7291 | 54.6 |
| 522 * | −73.02 | | | |
| | | 14.33 | 1.0000 | |
| 528 | 35.65 | | | |
| 530 | | 21.73 | 1.6405 | 60.1 |
| 532 | −67.27 | | | |
| | | 4.15 | 1.0000 | |
| 538 | −42.28 | | | |
| 540 | | 2.00 | 1.5927 | 35.3 |
| 542 | 28.97 | | | |
| | | 6.48 | 1.0000 | |
| 548 | −142.58 | | | |
| 550 | | 2.00 | 1.8080 | 22.7 |
| 552 | 85.77 | | | |
| | | 2.16 | 1.0000 | |
| 558 | 281.74 | | | |
| 560 | | 7.75 | 1.6405 | 60.1 |
| 562 | −50.29 | | | |
| | | 0.10 | 1.0000 | |
| 568 | 62.14 | | | |
| 570 | | 8.00 | 1.7550 | 52.3 |
| 572 | −97.45 | | | |

* aspherical surface

TABLE 2

| Aspheric coefficients: | |
|---|---|
| K (cone constant) | 0 |
| A4 | 0.601508*10⁻⁷ |
| A6 | 0.565724*10⁻⁹ |
| A8 | −0.223813*10⁻¹¹ |
| A10 | 0.330861*10⁻¹⁴ |

1. A system for stereoscopic cinema projection comprising:
a) at least one projector for projecting two images, one image for a first eye and one image for a second eye of a viewer;
b) a linear polarizer for polarizing the light emerging from the projector;
c) a respective projection lens in front of each of the at least one projectors;
d) a radial polarizer for light which projects the image for the first eye of the viewer;
e) a tangential polarizer for light which projects the image for the second eye of the viewer;
e1) wherein the radial and tangential polarizers are arranged at the output of the respective projection lens; and comprising
f) a metallic projection wall, onto which the images are projected; and comprising
g) a visual aid for both eyes (128, 129) of a viewer, wherein a spectacle lens for the first eye contains a radial polarizer and a spectacle lens (124) for the second eye (129) contains a tangential polarizer.

2. A system for stereoscopic cinema projection as recited in claim 1,
characterized
in that the at least one projector contains at least one DMD for projecting digitally stored image contents.

3. A system for stereoscopic cinema projection as recited in claim 2,
characterized
in that the system has an image field flattener lens element in the beam path between the at least one DMD and the at least one projection lens.

4. A system for stereoscopic cinema projection as recited in claim 1,
characterized
in that the system has an optical relay system in the beam path between the at least one DMD and the at least one projection lens.

5. A system for stereoscopic cinema projection as recited in claim 1,
characterized
in that the linear polarizer is a wire grid polarizer.

6. The system for stereoscopic cinema projection as recited in claim 5,
characterized
in that the linear wire grid polarizer is arranged between the at least one projector and the at least one projection lens.

7. A system for stereoscopic cinema projection as recited in claim 1,
characterized
in that the system has exactly one projector (102) and exactly one projection lens,
wherein the projection lens has a pair of imaging systems situated on both sides of an axial separating plane,
wherein the optical construction of the two imaging systems is identical.

8. A method for stereoscopic cinema projection comprising the following steps:
a) at least one projector projects two images, one image for a first eye and one image for a second eye of a viewer;
b) a linear polarizer polarizes the light emerging from the projector;
c) each of the two images is projected by means of a projection lens in front of each of the at least one projectors;
d) a radial polarizer polarizes the light which projects the image for the first eye of the viewer;
e) a tangential polarizer polarizes the light which projects the image for the second eye of the viewer;
e1) wherein the radial and tangential polarizers are arranged at the output of the respective projection lens;
f) the images are projected onto a metallic projection wall; and
g) by means of a visual aid, the images reach the two eyes of a viewer,
h) wherein a spectacle lens for the first eye of the visual aid contains a radial polarizer and a spectacle lens for the second eye contains a tangential polarizer.

9. A system for stereoscopic cinema projection as recited in claim,
characterized
in that the system has an optical relay system in the beam path between the at least one DMD and the at least one projection lens.

10. A system for stereoscopic cinema projection as recited in claim 3,
characterized
in that the system has an optical relay system in the beam path between the at least one DMD and the at least one projection lens.

11. A system for stereoscopic cinema projection as recited in claim 2,
characterized
in that the linear polarizer is a wire grid polarizer.

12. A system for stereoscopic cinema projection as recited in claim 3,
characterized
in that the linear polarizer is a wire grid polarizer.

13. A system for stereoscopic cinema projection as recited in claim 4,
characterized
in that the linear polarizer is a wire grid polarizer.

14. A system for stereoscopic cinema projection as recited in claim 9,
characterized
in that the linear polarizer is a wire grid polarizer.

15. A system for stereoscopic cinema projection as recited in claim 2,
characterized
in that the system has exactly one projector and exactly one projection lens,
wherein the projection lens has a pair of imaging systems situated on both sides of an axial separating plane, and
wherein the optical construction of the two imaging systems is identical.

16. A system for stereoscopic cinema projection as recited in claim 3,
characterized
in that the system has exactly one projector and exactly one projection lens,
wherein the projection lens has a pair of imaging systems situated on both sides of an axial separating plane, and
wherein the optical construction of the two imaging systems is identical.

17. A system for stereoscopic cinema projection as recited in claim 4,
characterized
in that the system has exactly one projector and exactly one projection lens,
wherein the projection lens has a pair of imaging systems situated on both sides of an axial separating plane, and
wherein the optical construction of the two imaging systems is identical.

18. A system for stereoscopic cinema projection as recited in claim 9,
characterized
in that the system has exactly one projector and exactly one projection lens,
wherein the projection lens has a pair of imaging systems situated on both sides of an axial separating plane, and
wherein the optical construction of the two imaging systems is identical.

19. A system for stereoscopic cinema projection as recited in claim 5,
characterized
in that the system has exactly one projector and exactly one projection lens,
wherein the projection lens has a pair of imaging systems situated on both sides of an axial separating plane, and
wherein the optical construction of the two imaging systems is identical.

20. A system for stereoscopic cinema projection as recited in claim 11,
characterized
in that the system has exactly one projector and exactly one projection lens,
wherein the projection lens has a pair of imaging systems situated on both sides of an axial separating plane, and
wherein the optical construction of the two imaging systems is identical.

21. A system for stereoscopic cinema projection as recited in claim 13,
characterized
in that the system has exactly one projector and exactly one projection lens,
wherein the projection lens has a pair of imaging systems situated on both sides of an axial separating plane, and
wherein the optical construction of the two imaging systems is identical.

22. A system for stereoscopic cinema projection as recited in claim 6,
characterized
in that the system has exactly one projector and exactly one projection lens,
wherein the projection lens has a pair of imaging systems situated on both sides of an axial separating plane, and
wherein the optical construction of the two imaging systems is identical.
